(19) United States
(12) Patent Application Publication
(10) Pub. No.: US 2023/0194674 A1
(43) Pub. Date: Jun. 22, 2023

(54) LIGHT EMISSION MODULE, LIGHT DETECTION AND RANGING SYSTEM AND LIGHT SCANNING METHOD

(71) Applicant: Industrial Technology Research Institute, Hsinchu (TW)

(72) Inventors: CHIA-YU HU, Tainan City (TW); YI-CHI LEE, Taichung City (TW); YUAN-DI CHEN, Tainan City (TW); JI-BIN HORNG, Tainan City (TW)

(21) Appl. No.: 17/558,630

(22) Filed: Dec. 22, 2021

(51) Int. Cl. G01S 7/481; G02B 27/09; G02F 1/29; G01S 17/08

(52) U.S. Cl. CPC G01S 7/4817; G02B 27/0955; G02F 1/29; G01S 17/08; G01S 7/4815; G02F 2202/10

(57) ABSTRACT

A light emission module includes a laser source, a beam steering element and a scanning-angle expanding lens set. The laser source is used for emitting a laser beam. The beam steering element is used for receiving the laser beam and splitting the laser beam into at least two laser beams. The scanning-angle expanding lens set, adjacent to the beam steering element, is configured to receive and integrate the at least two laser beams, and to control a spanning angle and a scanning angle between the at least two laser beams on a scanned object. The spanning angle is a visual angle of a vertical scan direction of the scanned object, and the scanning angle is another visual angle of a horizontal scan direction of the scanned object. In addition, a light emission module and a light scanning method are also provided.

### TECHNICAL FIELD

The present disclosure relates in general to a light emission module, a light detection and ranging system, and a light scanning method.

### BACKGROUND

The light detection and ranging (LiDAR) system is used for detecting and measuring an object such as a vehicle. The main structure of the LiDAR system is to integrate a laser source and scanning components (with or without rotational elements) to perform laser-beam scanning upon an object, such that distancing information thereabout can be obtained. Generally speaking, the LiDAR system can be a mechanical, quasi-solid or solid-state system. In particular, the mechanical LiDAR system is featured in bulky, vulnerable to mechanical shocks, limited resolution in the vertical direction due to the number of light sources, and the higher cost. On the other hand, the stability of the quasi-solid LiDAR system is yet to be verified. In addition, the solid-state LiDAR system is a flash-light system, not a scan system, and thus the detection ranged is pretty limited because energy for the required light source energy needs to cover a larger area.

In addition, rotating parts of the conventional LiDAR system may face problems in shock resistance, service life, risk of harming human naked eyes, insufficient signal resolution, low frame-rate update speed, and insufficient detection distance. Therefore, how to modify the existing LiDAR system so as further to improve the above-mentioned problems will be an issue urgent to be solved in the art.

Nevertheless, the recent technique of using the mature mass-produced reflective liquid crystal on silicon (LCoS) as the phase spatial light modulator (SLM) to develop the all-solid-state LiDAR system has encountered three technical difficulties to be broken through. Firstly, the rate (20-100 Hz) for updating the SLM screen to achieve the function of beam scanning cannot be compared with an axial scanning speed (up to kHz) of the quasi-solid MEMS (Micro electro mechanical system). Secondly, the LCoS filling rate and the optical system for phase conversion of the technique would make the diffraction efficiency less than 10%. Thirdly, the phase control is limited theoretically in the optical diffraction theory, and thus the scanning angle of the beams is generally less than 11 degrees.

### SUMMARY

In this disclosure, a light emission module, a light detection and ranging system and a light scanning method are provided to overcome the shortcomings of the conventional LiDAR systems. As a full solid-state non-rotational LiDAR system, at least 2 laser beams can be generated to increase the number of light points or the corresponding diameter of light, and to uplift the scanning speed. In addition, a design of the canning-angle expanding lens set is also introduced to overcome the encountered problems.

In one embodiment of this disclosure, a light emission module includes a laser source, a beam steering element and a scanning-angle expanding lens set. The laser source is used for emitting a laser beam. The beam steering element is used for receiving the laser beam and splitting the laser beam into at least two laser beams. The scanning-angle expanding lens set, adjacent to the beam steering element, is configured to receive and integrate the at least two laser beams, and to control a spanning angle and a scanning angle between the at least two laser beams on a scanned object. The spanning angle is a visual angle of a vertical scan direction of the scanned object, and the scanning angle is another visual angle of a horizontal scan direction of the scanned object.

In another embodiment of this disclosure, a light detection and ranging system includes a light emission module and a light-beam receiver module. The light emission module includes a laser source, a beam steering element and a scanning-angle expanding lens set. The laser source is used for emitting a laser beam. The beam steering element is used for receiving the laser beam and splitting the laser beam into at least two laser beams. The scanning-angle expanding lens set, adjacent to the beam steering element, is configured to receive and integrate the at least two laser beams, and to control a spanning angle and a scanning angle between the at least two laser beams on a scanned object. The spanning angle is a visual angle of a vertical scan direction of the scanned object, and the scanning angle is another visual angle of a horizontal scan direction of the scanned object. The light-beam receiver module includes a receiver lens set and a sensor module. The receiver lens set is configured to receive the laser beam reflected from the scanned object. The sensor module is configured to receive the laser beam transmitted from the receiver lens set.

In a further embodiment of this disclosure, a light scanning method includes the steps of: utilizing a phase deflection angle database to determine a scan strategy of a spatial light modulator upon a scanned object; based on the scan strategy, the spatial light modulator issuing at least four laser beams to the scanned object; and, utilizing the spatial light modulator to move the at least four laser beams on scanned object in at least one direction so as to fill gaps among the at least four laser beams.

As stated, according to the embodiments of this disclosure, the spatial light modulator is utilized to provide multiple light beams and the full solid-state non-rotational LiDAR system. By appropriately arranging the scanning-angle expanding lens set, limits upon the spatial light modulator can be lifted off.

Further, according to the embodiments of this disclosure, with the LCoS spatial light modulator and the sensor array, the frame rate can be substantially raised. For example, for a scan position at 300 m, when a wave length is 1550 nm, a beam diameter is 1.7 cm, a scanning angle is 2.8°, a scanning range is 12 m, and an angle switch rate is 60 Hz, then the scan time needs 30 minutes. In addition, if the beam diameter is raised to 6-12 cm and the number of light beams is greater than 2, the scan time would be reduced by at least 32 times.

### BRIEF DESCRIPTION OF THE DRAWINGS

FIG. 1A is a schematic view of an embodiment of the LiDAR system in accordance with this disclosure;

FIG. 1B is a schematic view of another embodiment of the LiDAR system in accordance with this disclosure;

FIG. 2 shows schematically an embodiment of a combination of the beam steering element and the scanning-angle expanding lens set of the LiDAR system in FIG. 1A or FIG. 1B;

FIG. 3A shows schematically an embodiment of the phase of the spatial light modulator in accordance with this disclosure;

FIG. 3B shows schematically another embodiment of the phase of the spatial light modulator in accordance with this disclosure;

FIG. 4A to FIG. 4D demonstrate schematically an embodiment of the scan-path method in accordance with this disclosure;

FIG. 5A to FIG. 5D demonstrate schematically another embodiment of the scan-path method in accordance with this disclosure;

FIG. 6A is a schematic view of an embodiment of the scanning-angle expanding lens set in accordance with this disclosure; and

FIG. 6B is a schematic view of another embodiment of the scanning-angle expanding lens set in accordance with this disclosure.

### DETAILED DESCRIPTION

In the following description, specific embodiments of the present disclosure will be further described in conjunction with the accompanying drawings and examples, and the following examples are only used to further and clearly illustrate technical solutions of the present disclosure, not to limit the scope of the present disclosure.

It should be noted that, in the following embodiments, the so-called “first” and “second” are used to describe different elements, not for limiting thereto. In addition, for convenience and clarity, the thickness or size of each element in the drawings is shown in an exaggerated, omitted or rough manner for the understanding and reading of those skilled in the art. Also, the size of each element in any of the drawings is not to demonstrate the actual size of the element, thus is not used to limit the conditions for the implementation of the present disclosure, and therefore has no technical substantive significance. Any modification of the structure, change of the proportional relationship or adjustment of the size will not affect the effect and achievement of the present disclosure. For the purposes of this disclosure, they should still fall within the scope of the technical content disclosed in this disclosure.

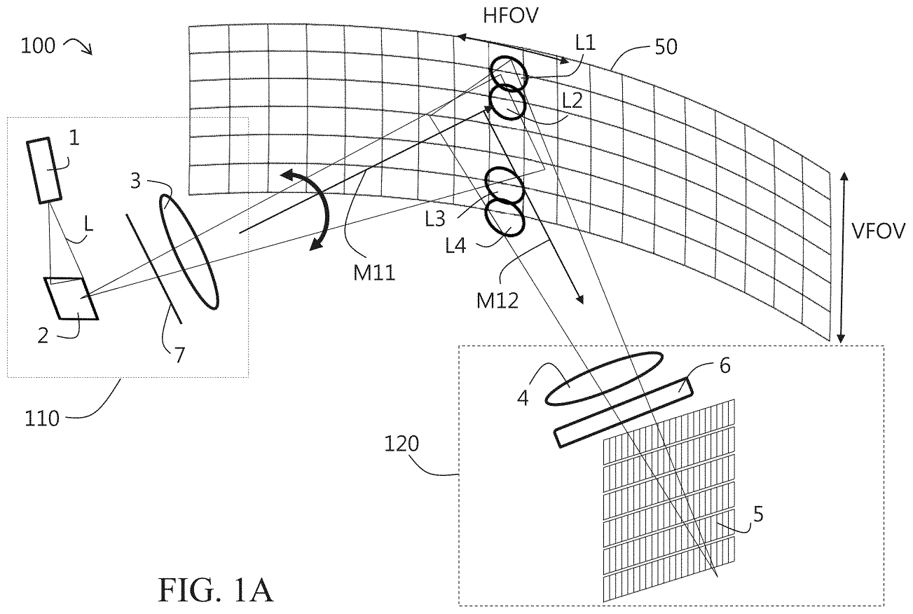

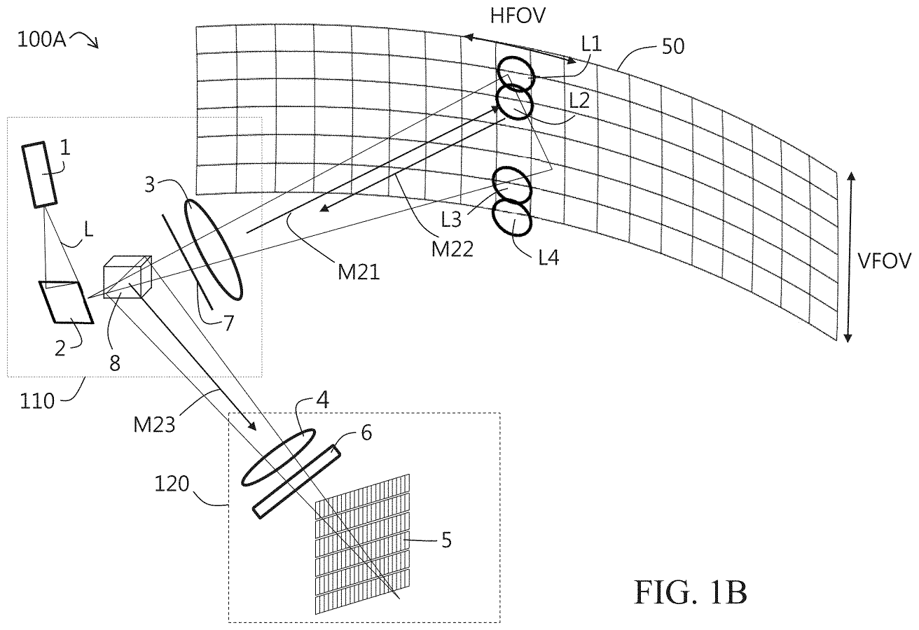

FIG. 1A and FIG. 1B demonstrate schematically different embodiments for the LiDAR system in accordance with this disclosure. As shown, an emitted beam M11 and a corresponding received beam M12 of FIG. 1A are arranged to follow different directions, and another emitted beam M21 and a corresponding received beam M22 of FIG. 1B are arranged to follow the same direction. In any of these two embodiments, the LiDAR system 100, 100A includes a light emission module 110 and an optical receiver module 120. The light emission module 110 can be applied to scan a scanned object 50, and the optical receiver module 120 is configured to receive and detect reflected light beams from the scanned object 50.

In this embodiment, the light emission module 110 includes a laser source 1, a beam steering element 2, a scanning-angle expanding lens set 3 and a block mask 7. The laser source 1, used for emitting a laser beam L, can be a fiber laser device, such as a CW (continuous wave) fiber laser device, or any fiber laser device or diode including light with adjustable pulse widths and frequencies. However, the wave length of the laser beam L is not in this disclosure. In one embodiment, the laser beam has a wave length ranging within 900 nm-1550 nm, in which the 1550 nm is a wave length safe to naked eyes.

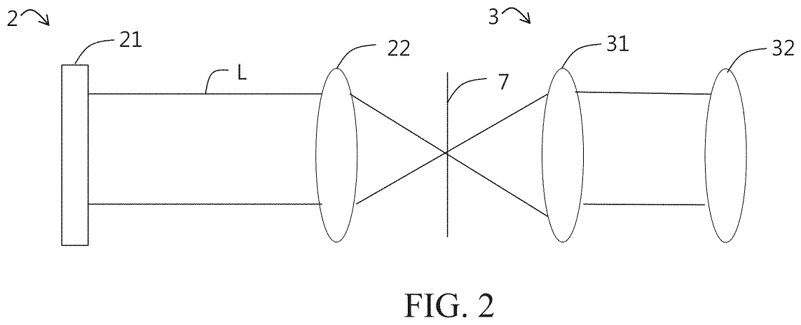

In this embodiment, the beam steering element 2 is used to receive the laser beam L emitted by the laser source 1. In an example not shown herein, a beam expander or reflector is provided between the beam steering element 2 and the laser source 1, practically for expanding a diameter of the laser beam L or reducing a divergent angle thereof. The beam steering element 2 can include a spatial light modulator (SLM) 21 and a lens set 22 of Fourier transform, as shown in FIG. 2. The spatial light modulator 21, as a light adjuster of a liquid crystal on silicon (LCoS), is an optical element capable of modulating amplitudes and phases of the incident light, and is configured to generate a diffractive pattern to steer the laser beam L and control a phase pattern of the spatial light modulator 21, in which the size and period of the phase pattern are controllable. The lens set 22 of Fourier transform is configured to receive the laser beams L from the spatial light modulator 21, and to perform a Fourier transform upon the laser beams L so as to focus at least two of these laser beams L.

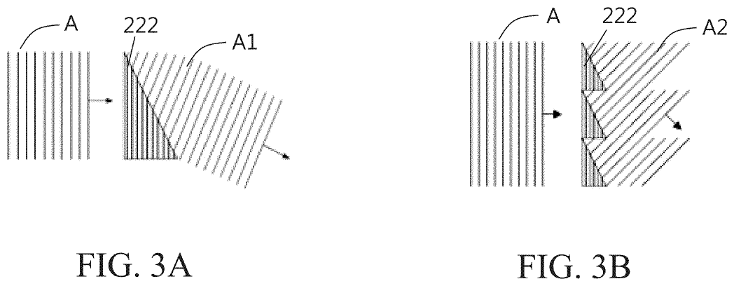

In one embodiment, the spatial light modulator 21 is used to modulate the phase 222 of a wedge lens or a grating having a period of 8 um-300 um. For example, as shown in FIG. 3A, the phase A is transformed into a phase A1 by the lens set 22 of Fourier transform (FIG. 2). In the example of FIG. 3B, the phase A2 is divided into a plurality of sections, and each of the sections of the phase A is deflected by the lens set 22 so as to produce corresponding phase A2. Thereupon, a plurality of light beams can be produced from the same light beam. For example, the spatial light modulator 21 can perform controls upon diameters and angles of light beams with more than two phase sections or overlapped phases from a grating and a lens.

In one embodiment, a distance between the spatial light modulator 21 and the scanned object 50 can be a variable. Different distances would be corresponding to different phase densities, and/or different spacing and angling among light beams with respect to the phase pattern. Thus, according to this disclosure, a data table can be established for phases and deflection angles with respect to different distances. This data table can include phase patterns, grey levels, spatial scanning angles, coordinates and light-beam diameters of the spatial phase modulator. According to the data table and corresponding interpolation operations, tremendous time in calculating the phases during a scanning process can be saved, and thus the scan speed can be raised. Accordingly, a light scanning method of this disclosure includes steps to build a phase deflection angle database as follows. Firstly, based on different distances between the spatial light modulator 21 and the scanned object 50, corresponding phase patterns can be obtained. These distances can be 50 m, 100 m, 200 m, 300 m and so on. Then, for each of these distances (for example, 50 m, 100 m, 200 m and 300 m), a corresponding beam steering position can be obtained. Then, according to all these phase patterns and beam steering positions, the phase deflection angle database can be built. Thereafter, phase data corresponding to the spatial light modulator 21 can be located by referring relative parameters, such as the distances, to the data table in a lookup-table manner. In addition, if the distance is 75 m, then an interpolation calculation between 50 m and 100 m can be performed to derive the phase data of the spatial light modulator 21 for the example of the 75 m distance. Namely, in this disclosure, the data table can be utilized to determine the scan strategy of the spatial light modulator 21.

Referring back to FIG. 1A and FIG. 1B, the beam steering element 2 is configured to split the laser beam L into four laser beams L1, L2, L3, L4, and the scanning-angle expanding lens set 3, adjacent to the beam steering element 2, is configured for receiving and integrating at least two laser beams L that pass through the beam steering element 2, and for controlling the spanning angles and the scanning angles on the scanned object 50 with respect to these laser beams L. In this embodiment, the spanning angle is the visual angle of the vertical scan direction VFOV of the scanned object 50, and the scanning angle is the visual angle of the horizontal scan direction HFOV of the scanned object 50, in which HFOV>90.

In one embodiment, the block mask 7, disposed between the beam steering element 2 and the scanning-angle expanding lens set 3, is to perform spatial filtering for filtering out the laser beams L of order 0, other unwanted or redundant diffraction orders, such as the laser beam L that is not phase-modulated by spatial light modulator 21. According to practical needs, the quantity of the filtered laser beam L of order 0, other unwanted or redundant diffraction orders can be adjusted. For example, if the number of the laser beams L of FIG. 1A to pass through the scanning-angle expanding lens set 3 is 5, then, after the filtering by the block mask 7, four of the laser beams L are left to reach the scanned object 50.

In detail, the scanning-angle expanding lens set 3, as a compound spherical lens set, as shown in FIG. 2, includes a first lens 31 and a second lens 32, in which the combination of the first lens 31 and the second lens 32 can be a combination consisted of a spherical lens and at least a non-spherical reflector set. Thereupon, the scanning-angle expanding lens set 3 can control the scanning angle among these laser beams L to be greater than 90°, such that basic requirements for implementing the LiDAR system 100 can be fulfilled. In addition, the beam steering element 2 can be utilized to adjust the distance to the scanning-angle expanding lens set 3, so as to adjust the spanning angle among these laser beams L of the scanning-angle expanding lens set 3 to be greater than 30°.

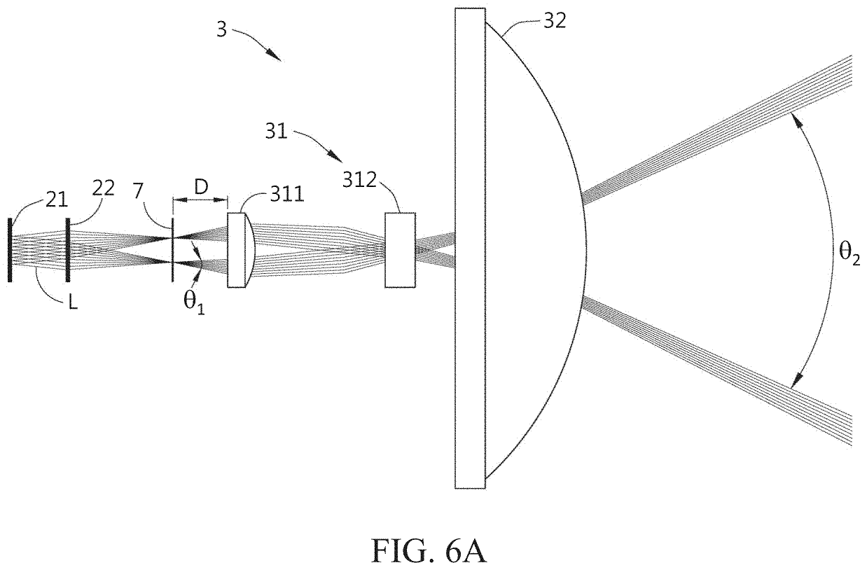

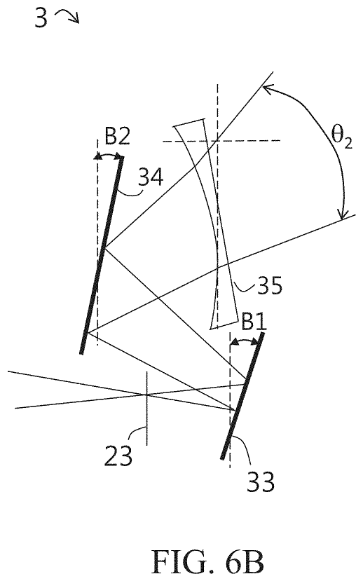

As shown in FIG. 6A, the catadioptric theory for the panoramic lens set is schematically explained. After orderly passing through the spatial light modulator 21 and the lens set 22 of Fourier transform, the laser beams L are focused at the block mask 7, and the laser beams L passed the block mask 7 would demonstrate an opening angle θ₁. As described above, the scanning-angle expanding lens set 3 includes the first lens 31 and the second lens 32. The first lens 31, as a positive focal-length lens set, can include a receiver lens 311 and a diverging lens 312. The block mask 7 is spaced from the receiver lens 311 by a distance D. The laser beams L passed the block mask 7 would be collected by the receiver lens 311. After being collected and then modulated by the receiver lens 311, the laser beams L pass through the diverging lens 312 to have the light beams able to match aperture positions of the second lens 32. Namely, in this embodiment, by utilizing the receiver lens 311 and the diverging lens 312, the laser beams L can be modulated into the light-beam distribution range of the second lens 32. In this disclosure, the second lens 32 can be an expanded scanning-angle focal-length lens set. Before entering the second lens 32, the distances D, the opening angle θ1 and the light-beam distribution range would be modulated so as to control the scanning angle θ₂ of the laser beams L, in which the light-beam distribution range includes the distance from the diverging lens 312 to the second lens 32, and the radius of the aperture for the corresponding laser beam L to enter the second lens 32.

In another embodiment, as shown in FIG. 6B, a scanning-angle expanding lens set 3 having a free-form surface is schematically shown. This scanning-angle expanding lens set 3 is consisted of two inclined first reflectors 33, a second reflector 34 and a curved lens 35. In an exemplary example, the first reflector 33 has a tilt rotation angle B1 of 18°, the second reflector 34 has a tilt rotation angle B2 of 9°, and the curved lens 35 as a negative or positive focal length lens set has a rotation angle of 22°. In this example, the non-spherical curvature radius of the first reflector 33 is greater than 300 mm, and the non-spherical curvature radius of the second reflector 34 is less than −100 mm, such that the deflection angle can be used to expand the scanning angle. After orderly passing through the first reflector 33 and then the second reflector 34, the scanning angle of the laser beams can be controlled. Then, the curved lens 35, as a negative or positive focal length lens set, is utilized to control the divergent angle of the light beams, so as to further control the spanning angle of the laser beams. Thereupon, the scanning angle θ₂ of the laser beam can be expanded, such that the limit upon the phase modulation according to the optical diffraction theory can be waived. Theoretically, the scanning angle θ₂ is less than 11° (λ=1.55 um, the grating period Λ is 8 um, the theoretical light-deflection angle is

$$sin θ = \frac{m * λ}{Λ} ,$$

and m is the diffraction order=1).

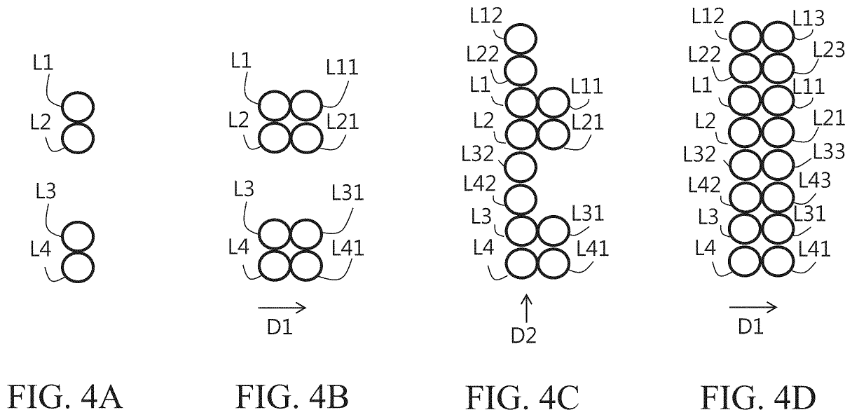

Referring back to FIG. 1A or FIG. 1B, four laser beams L1, L2, L3, L4 are shown. It is noted that gaps exist among these four laser beams L1, L2, L3, L4. In order to fill these gaps, a light scanning method according to this disclosure is also provided. Firstly, beside the phase deflection angle database is utilized to determine the scan strategy of the spatial light modulator 21 upon the scanned object 50, a scan-path method is also provided to have the spatial light modulator 21 to follow the scan strategy to issue these four laser beams to the scanned object 50. Then, these four laser beams L1, L2, L3, L4 on the scanned object 50 are shifted toward at least one direction so as to fill the gaps among the laser beams L1, L2, L3, L4. As shown in FIG. 4A, four laser beams L1, L2, L3, L4 are present. Then, according to a scan strategy, as shown in FIG. 4B, the beam steering element 2 drives these four laser beams L1, L2, L3, L4 to move in a first direction D1 (right-ward in the figure) so as to produce another four laser beams L11, L21, L31, L41. Then, as shown in FIG. 4C, in order to fill the gap between the two laser beams L2, L3, the beam steering element 2 is utilized to control the laser beams L1, L2, L3, L4 to move in a second direction D2 (upward in the figure), such that laser beams L12, L22 are produced above the laser beams L1, L2, respectively, and also laser beams L32, L42 are produced above the laser beams L3, L4, respectively. Thereupon, the gap between the laser beams L2, L3 is filled by the laser beams L32, L42. Then, it is noted that gaps exist by neighboring laterally the laser beams L12, L22, L32, L42. Thus, by having the beam steering element 2 to control these laser beams L12, L22, L32, L42 to move in the first direction D1, corresponding laser beams L13, L23, L33, L43 would be produced. In comparison with the prior art whose light beam is moved point by point, the foregoing light-shifting strategy of this disclosure of this disclosure can be followed to fill the gaps in the phase pattern, no matter how many the laser beams are.

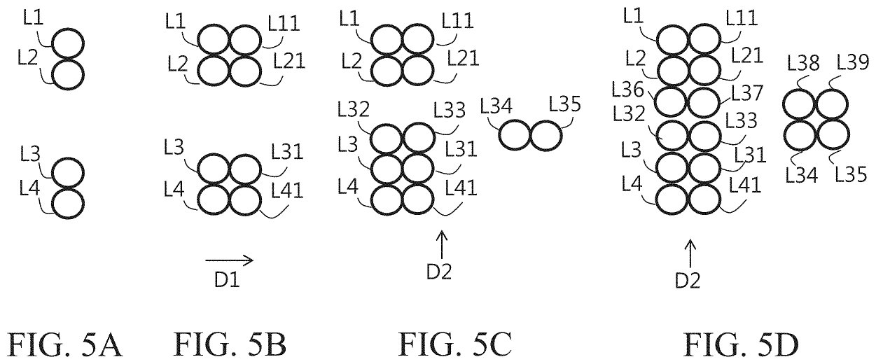

In this disclosure, the scan-path displacement pattern is not limited thereto. Referring to FIG. 5A to FIG. 5D, another displacement pattern is shown. In this displacement pattern, movements from FIG. 5A to FIG. 5B are resembled to those from FIG. 4A to FIG. 4B, and thus details thereabout would be omitted herein. Then, as shown in FIG. 5C, the beam steering element 2 is utilized to control the laser beams L3, L31 to move in the second direction D2, forward firstly and then sideward, so as to increase laser beams L32, L34, L33, L35. Then, as shown in FIG. 5D, the beam steering element 2 is utilized again to control the laser beams L32, L33, L34, L35 to move in the second direction D2 so as to provide laser beams L36, L37, L38, L39.

After the light emission module 110 is elucidated above, then referring back to FIG. 1A, the optical receiver module 120 would be introduced as follows. In this embodiment, the optical receiver module 120 includes a receiver lens set 4 and a sensor module 5. The receiver lens set 4 is configured to receive the laser beam reflected back from the scanned object 50. This reflected laser beam would be further transmitted to the sensor module 5. The receiver lens set 4 can be any combination of a beam splitter, a reflector and lenses. On the other hand, the sensor module 5 receives the laser beam from the receiver lens set 4, and further detects and analyzes the laser beam. The sensor module 5 can be a single-photon avalanche diode (SPAD) sensor array, an avalanche photodiode (APD) array, or a charge-coupled device (CCD) sensor array, but not limited thereto. In one embodiment, the optical receiver module 120 further includes a polarizer 6 disposed between the receiver lens set 4 and the sensor module 5. With this polarizer 6, the light beams reflected back from scanned object 50 can be eliminated.

In another embodiment, referring to FIG. 1B in comparison to FIG. 1A, the emitted beam M21 is coaxial with the received beam M22. This embodiment further includes a polarizing element 8 disposed between the beam steering element 2 and the scanning-angle expanding lens set 3. The polarizing element 8 is configured to reflect the laser beam L reflected from the scanned object 50 (i.e., the received beam M22, which is produced by the scanned object 50 from reflecting the emitted beam M21) to produce a reflected beam M23 directed to the receiver lens set 4.

In summary, according to the aforesaid embodiments of this disclosure, the spatial light modulator is utilized to provide multiple light beams and the full solid-state non-rotational LiDAR system. In addition, by appropriately arranging the scanning-angle expanding lens set, limits upon the spatial light modulator can be lifted off.

Further, according to the aforesaid embodiments of this disclosure, with the LCoS spatial light modulator and the sensor array, the frame rate can be substantially raised.

According to the aforesaid embodiments of this disclosure, the scanning-angle expanding lens set can be utilized to expand the scanning angle of light beam.

In addition, according to the aforesaid embodiments of this disclosure, by integrating multiple laser beams with the scan-path method, the entire scan speed can be increased.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A light emission module, comprising:
a laser source, used for emitting a laser beam;
a beam steering element, used for receiving the laser beam and splitting the laser beam into at least two laser beams; and
a scanning-angle expanding lens set, adjacent to the beam steering element, configured to receive and integrate the at least two laser beams, and to control a spanning angle and a scanning angle between the at least two laser beams on a scanned object; wherein the spanning angle is a visual angle of a vertical scan direction of the scanned object, and the scanning angle is another visual angle of a horizontal scan direction of the scanned object.

2. The light emission module of claim 1, wherein the scanning angle is greater than 90°.

3. The light emission module of claim 1, wherein the spanning angle is greater than 30°.

4. The light emission module of claim 1, wherein the scanning-angle expanding lens set is a compound spherical lens set.

5. The light emission module of claim 4, wherein the compound aspherical lens set includes a spherical lens and at least one aspherical set.

6. The light emission module of claim 1, wherein the compound spherical lens set includes a positive focal-length lens set and an expanded scanning-angle focal-length lens set.

7. The light emission module of claim 6, wherein the positive focal-length lens set includes a receiver lens and a diverging lens.

8. The light emission module of claim 1, wherein the beam steering element includes a spatial light modulator for steering the laser beam.

9. The light emission module of claim 8, wherein the spatial light modulator is a light adjuster of a liquid crystal on silicon.

10. The light emission module of claim 8, wherein the beam steering element includes a lens set of Fourier transform for receiving the laser beam from the spatial light modulator and further performing a Fourier transform upon the laser beam so as to focus the at least two laser beams.

11. The light emission module of claim 10, wherein the spatial light modulator is configured to modulate phases of a prismatic lens or a grating, and a grating periodical range of the prismatic lens is between 8 um and 1000 mm.

12. The light emission module of claim 1, wherein the laser source is a pulse laser source, for example: fiber laser.

13. The light emission module of claim 1, wherein the laser beam has a wave length ranging between 900 nm and 1550 nm.

14. The light emission module of claim 1, further including a polarizing element disposed between the beam steering element and the scanning-angle expanding lens set, and configured to reflect the laser beam from the scanned object.

15. The light emission module of claim 1, further including a block mask for filtering out excessive refractive laser beams.

16. A light detection and ranging system, comprising:
a light emission module, including:
a laser source, used for emitting a laser beam;
a beam steering element, used for receiving the laser beam and splitting the laser beam into at least two laser beams; and
a scanning-angle expanding lens set, adjacent to the beam steering element, configured to receive and integrate the at least two laser beams, and to control a spanning angle and a scanning angle between the at least two laser beams on a scanned object; wherein the spanning angle is a visual angle of a vertical scan direction of the scanned object, and the scanning angle is another visual angle of a horizontal scan direction of the scanned object; and
a light-beam receiver module, including:
a receiver lens set, configured to receive the laser beam reflected from the scanned object; and
a sensor module, configured to receive the laser beam transmitted from the receiver lens set.

17. The light detection and ranging system of claim 16, wherein the scanning angle is greater than 90°.

18. The light detection and ranging system of claim 16, wherein the spanning angle is greater than 30°.

19. The light detection and ranging system of claim 16, wherein the scanning-angle expanding lens set is a compound spherical lens set.

20. The light detection and ranging system of claim 19, wherein the compound spherical lens set includes a spherical lens and at least one non-spherical reflector set.

21. The light detection and ranging system of claim 19, wherein the compound spherical lens set includes a positive focal-length lens set and an expanded scanning-angle focal-length lens set.

22. The light detection and ranging system of claim 21, wherein the positive focal-length lens set includes a receiver lens and a diverging lens.

23. The light detection and ranging system of claim 16, wherein the beam steering element includes a spatial light modulator for steering the laser beam.

24. The light detection and ranging system of claim 23, wherein the spatial light modulator is a light adjuster of a liquid crystal on silicon.

25. The light detection and ranging system of claim 23, wherein the beam steering element includes a lens set of Fourier transform for receiving the laser beam from the spatial light modulator and further performing a Fourier transform upon the laser beam so as to focus the at least two laser beams.

26. The light detection and ranging system of claim 23, wherein the spatial light modulator is configured to modulate phases of a prismatic lens or a grating, and a grating periodical range of the prismatic lens is between 8 um and 1000 mm.

27. The light detection and ranging system of claim 16, wherein the laser source is a fiber laser.

28. The light detection and ranging system of claim 16, wherein the laser beam has a wave length ranging between 900 nm and 1550 nm.

29. The light detection and ranging system of claim 16, further including a polarizer disposed between the receiver lens set and the sensor module.

30. The light detection and ranging system of claim 16, further including a polarizing element disposed between the beam steering element and the scanning-angle expanding lens set, and configured to reflect the laser beam from the scanned object.

31. The light detection and ranging system of claim 16, further including a block mask for filtering out excessive refractive laser beams.

32. A light scanning method, comprising the steps of:
utilizing a phase deflection angle database to determine a scan strategy of a spatial light modulator upon a scanned object;
based on the scan strategy, the spatial light modulator issuing at least four laser beams to the scanned object; and
utilizing the spatial light modulator to move the at least four laser beams on scanned object in at least one direction so as to fill gaps among the at least four laser beams.

33. The light scanning method of claim 32, further including a step of building the phase deflection angle database, wherein the step of building the phase deflection angle database includes the steps of:
according to a plurality of distances between the spatial light modulator and the scanned object, obtaining corresponding phase patterns;
measuring a plurality of beam steering positions corresponding to the plurality of distances; and
according to the phase patterns and the plurality of beam steering positions, establishing the phase deflection angle database.

34. The light scanning method of claim 32, in the step of “according to a plurality of distances between the spatial light modulator and the scanned object, obtaining corresponding phase patterns”, further including a step of locating phase data in a lookup table with respect to the spatial light modulator.
